(19) United States
(12) Patent Application Publication
(10) Pub. No.: US 2018/0157700 A1
(43) Pub. Date: Jun. 7, 2018

(54) STORING AND VERIFYING EVENT LOGS IN A BLOCKCHAIN

(71) Applicant: International Business Machines Corporation, Armonk, NY (US)

(72) Inventors: Craig L. Roberts, Talsamau (GB); Jamie Windley, Bristol (GB)

(21) Appl. No.: 15/370,642

(22) Filed: Dec. 6, 2016

(51) Int. Cl. G06F 17/30

(52) U.S. Cl. CPC G06F 17/30371; G06F 17/30958

(57) ABSTRACT

A blockchain related to transactions may be referenced for various purposes and may be accessed for ledger verification. One example method of operation may comprise one or more of receiving an event log with events which occurred during operation of the computer, generating a hash value for the event log, adding details of the event log and the hash value as a transaction to a distributed blockchain, and storing the event log in a file store.

### TECHNICAL FIELD

This application relates to using a blockchain to store event logs, and more particularly, to storing event logs for integrity verification.

### BACKGROUND

During operation, computer systems often generate event logs, indicating events that have occurred during the operation of hardware, operating systems, applications and other computer components. What is needed is a manner to verify an integrity of the event logs to ensure event data is accurate, including individual events within the event logs, and to verify that the event logs have not been altered.

### SUMMARY

One example embodiment may include a method comprising one or more of receiving an event log comprising events which occurred during operation of the computer, generating a hash value for the event log, adding details of the event log and the hash value as a transaction to a distributed blockchain, and storing the event log in a file store.

Another example embodiment may include a system comprising one or more of an event log generator configured to generate an event log comprising events which occurred during operation of the computer, a hash generator configured to generate a hash value for the event log, a blockchain manager module configured to add details of the event log and a hash value as a transaction to a distributed blockchain and a file store configured to store the event log.

A further example embodiment may include a non-transitory computer-readable storage medium having computer-readable program code that when executed by a processor is configured to perform one or more of receiving an event log comprising events which occurred during operation of the computer, generating a hash value for the event log, adding details of the event log and the hash value as a transaction to a distributed blockchain and storing the event log in a file store.

### BRIEF DESCRIPTION OF THE DRAWINGS

FIG. 1 is a schematic diagram of a system in accordance with an embodiment of the application.

FIG. 2 is a schematic diagram of a system in accordance with an embodiment of the application.

FIG. 3 is a flowchart illustrating the operation of storing an event log in accordance with an embodiment of the application.

FIG. 4 is a flowchart illustrating the operation of a system when verifying the integrity of an event log in accordance with an embodiment of the application.

FIG. 5 illustrates an example system entity configured to support one or more of the example embodiments in accordance with an embodiment of the application.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

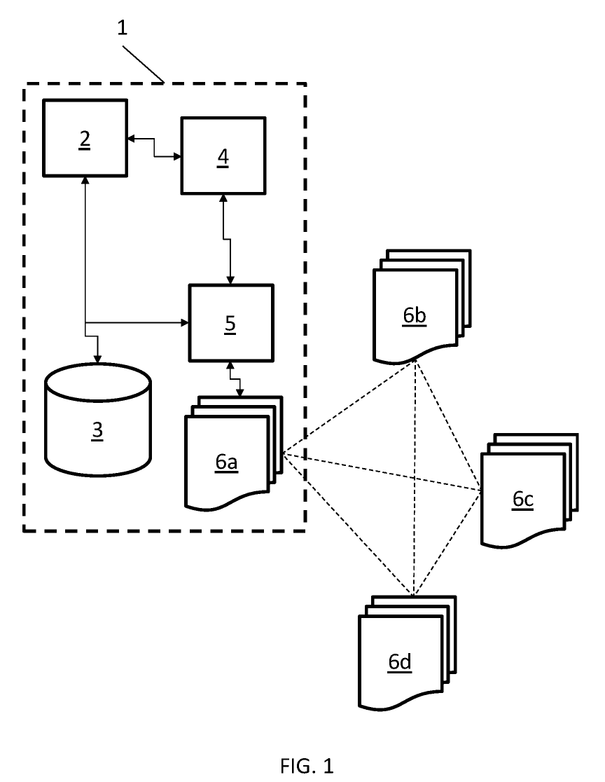

FIG. 1 illustrates a computer system, such as a personal computer, a server, network device, sensor or any other system comprising a processor and memory, integrated with a blockchain. The computer system 1 includes an event log generator 2, which generates event logs indicative of events which occurred during an operation of the computer system 1. The event logs may, for example, record operating system events, information about hardware operations, actions performed by a software application, or any other type of event that could or should be logged for integrity and/or management purposes. Event logs may include any information which may be well known to one skilled in the art. An event log may be a set of logged events for a particular time period, for example, or even a single logged event. Thus, while the event log may be a complete log file generated by the computer system 1, it may also be a subset of events from such a log file. For example, each event log may include a set of events logged since a preceding event log was generated. All generated event logs may be stored together in a single log file. Each new event log may be concatenated onto an end of the existing log file event log.

The computer system 1 further includes a file store 3 and a hash generator 4, both of which are in communication with the event log generator 2. The file store 3 stores event logs generated by the event log generator 2, and the hash generator 4 generates hash values for event logs generated by the event log generator 2. The computer system 1 further includes a blockchain manager 5, which communicates with both the event log generator 2 and the hash generator 4. The blockchain manager 5 adds details of event logs generated by the event log generator 2, including their hash values as generated by the hash generator 4, to a distributed blockchain system. The computer system 1 hosts a local copy of the blockchain 6a, with other copies of the blockchain 6b, 6c and 6d being hosted on other, remote and independent computer systems as part of a distributed blockchain system. According to other embodiments, the blockchain instances could reside on the logging devices themselves. The blockchain manager may also be on the computer system that generated the log.

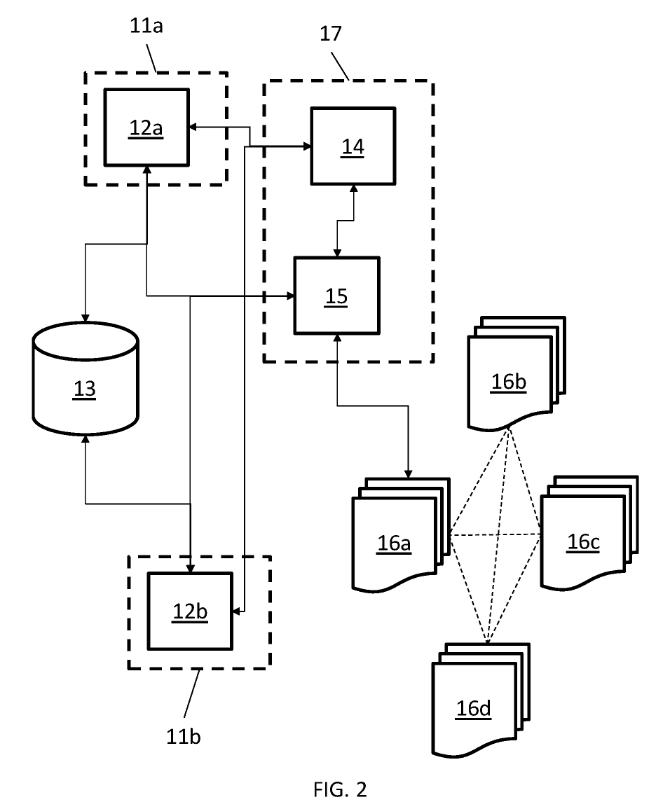

FIG. 2 illustrates another example embodiment of an event log blockchain management system. The system includes a first computer system 11a with a first event log generator 12a, and second computer system 11b comprising a second event log generator 12b. The first event log generator 12a and the second event log generator 12b are in communication with a file store 13, which is not part of either the first computer system 11a or the second computer system 11b. The system further includes an event log verification manager 17, which includes a hash generator 14 and blockchain manager 15, which are in communication with each other. The first event log generator 12a and second event log generator 12b are in communication with both the hash generator 14 and the blockchain manager 15. The blockchain manager 15 is in communication with a copy of the blockchain 16a, which in the present example is hosted on a remote and independent computer system rather than on the event log verification manager 17 with the blockchain manager 15. Copies of the blockchain 16b, 16c and 16d are hosted on other, remote and independent computer systems.

One skilled in the art will appreciate that the configurations are equally applicable to other variants of the systems of FIGS. 1 and 2 in accordance with other alternative embodiments. For example, there could be multiple computer systems with event log generators, and/or one or more computer systems could include multiple event log generators. An administrator computer system could include the file store, with other computer systems storing their event logs in that file store. Similarly, the administrator computer system could include the hash generator and the blockchain manager, with the other computer systems using those same configurations as well.

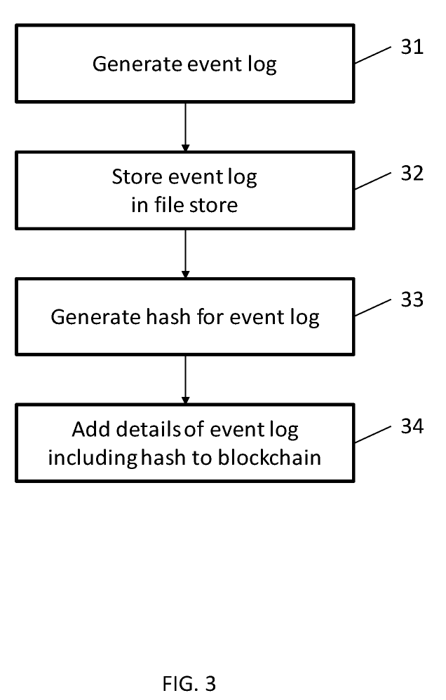

FIG. 3 illustrates an example method of storing an event log in the blockchain. Referring to FIG. 3, one or more of the following steps may occur. A new event log is generated by the event log generator 2 (step 31). The event log generator 2 may, for example, generate a new event log on a periodic basis, or in response to the occurrence of a particular event. The event log generator 2 sends the event log to the file store 3, which stores the event log (step 32). The event log generator 2 also sends the event log to the hash generator 4, which generates a hash value for the event log (step 33), in particular, a hash of the bytes making up the content of the event log. One skilled in the art will appreciate that this may be done in various different ways, to give just one example using the MD5 hash algorithm. Events may include any network device or application that generates actions which could be regarded as an event, such as a ‘User login’ from a server, a ‘Firewall deny’ message created from a firewall, a ‘Virus detected’ message from an endpoint application, etc. The log may be a file with many different events or just one individual event/message.

The event log generator 2 sends details of the event log to the blockchain manager 5, including the name and path in the file store 3 with which it is stored and a timestamp indicating when the event log was generated, and the hash generator 4 sends the hash value it has generated for the event log to the blockchain manager 5. The blockchain manager 5 then creates a blockchain transaction recording those details, including the hash value, and adds the transaction to the distributed blockchain system by adding it to the local copy of the blockchain 6a (step 34). The transaction will be copied to the other copies of the blockchain 6b, 6c and 6d of the distributed blockchain system. Further, at least under normal circumstances, it will not be possible for an individual or program with malicious intent to alter the transaction without the fact that they have done so being evident by the blockchain stored data.

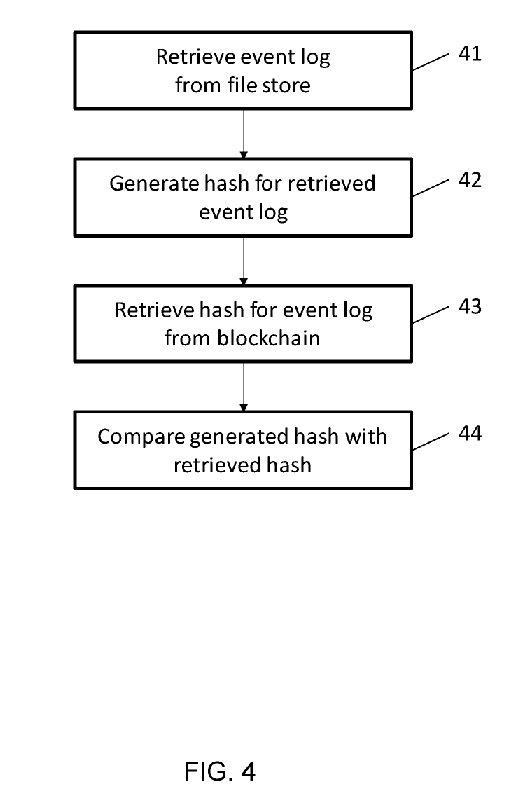

FIG. 4 illustrates another example method of operation for verifying event logs in the blockchain. Referring to FIG. 4, one or more of the following steps may occur. The event log which is to be verified is retrieved from the file store 3 (step 41). It is sent to the hash generator 4, which generates a hash value for the retrieved event log (step 42). The hash value is newly generated from the retrieved event log, even though a hash value will have been generated previously when the event log was initially generated and stored. The previously generated hash value for the event log, as generated when the event log was initially generated and stored, is retrieved from the local copy of the blockchain 6a (step 43), in which it is stored as a blockchain transaction with the details of the event log. The newly generated hash value for the retrieved event log is then compared to the hash value for the event log stored in the distributed blockchain system (step 44), and if the hash values are the same than the retrieved event log is verified as being accurate and unmodified.

Hashing may be performed for each individual event; however, events may be hashed as groups of events are accumulated. In the process of hashing each event, it is not necessary to store a copy in the local file system. The event could simply be stored straight to the blockchain while being hashed, so it can just be viewed/accessed/verified from that location. In another example, the local copy may be maintained and have a process which verifies the local copy versus the copy in the blockchain.

In one example, a retrieved event log is verified when it is identical to the event log as originally generated and stored in the blockchain (i.e., unaltered). This is because only identical files will give the same hash values. Or, at least due to the nature of hash functions, it is extremely unlikely that different event logs will yield the same hash value, and it would be practically difficult to find another event log that yielded a same hash value as the original event log. Further, due to the nature of distributed blockchain systems, transactions added to the blockchain cannot be altered. In addition, any event log can be verified without earlier event logs needing to be verified, unlike, for example, in known event log verification systems that use “hash chaining.”

While the present invention has been described and illustrated with reference to particular embodiments, it will be appreciated by those of ordinary skill in the art that the invention lends itself to many different variations not specifically illustrated herein. For example, it will be appreciated that the steps of operation described above could be performed in different orders or in parallel, for example the event logs could be stored in the file store only after their hash values had been generated and stored in transactions in the distributed blockchain system.

The present invention may be a system, a method, and/or a computer program product. The computer program product may include a computer readable storage medium (or media) having computer readable program instructions thereon for causing a processor to carry out aspects of the present invention.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

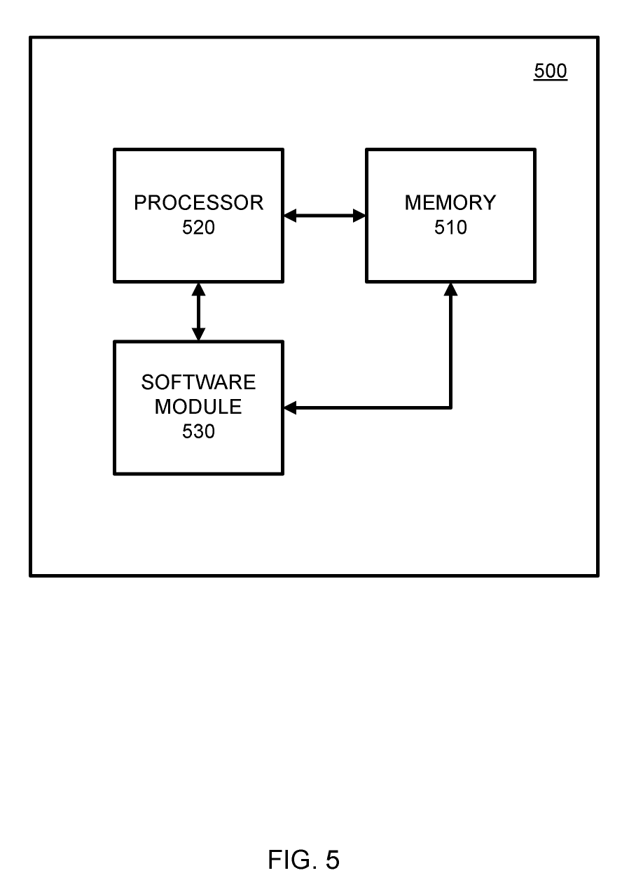

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 5 illustrates an example network element 500, which may represent or be integrated in any of the above-described components, etc.

As illustrated in FIG. 5, a memory 510 and a processor 520 may be discrete components of a network entity 500 that are used to execute an application or set of operations as described herein. The application may be coded in software in a computer language understood by the processor 520, and stored in a computer readable medium, such as, a memory 510. The computer readable medium may be a non-transitory computer readable medium that includes tangible hardware components, such as memory, that can store software. Furthermore, a software module 530 may be another discrete entity that is part of the network entity 500, and which contains software instructions that may be executed by the processor 520 to effectuate one or more of the functions described herein. In addition to the above noted components of the network entity 500, the network entity 500 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving an event log comprising events which occurred during operation of a computer;
generating a hash value for the event log;
adding details of the event log and the hash value as a transaction to a distributed blockchain; and
storing the event log in a file store.

2. The method as claimed in claim 1, wherein the event log is a log file.

3. The method as claimed in claim 1, wherein the details of the event log comprise a path of the event log and a name of the event log.

4. The method as claimed in claim 1, wherein the details of the event log comprise a timestamp indicating the event log was generated.

5. The method as claimed in claim 1, wherein the transaction is added to a copy of the distributed blockchain maintained by the computer.

6. The method as claimed in claim 1, further comprising:
retrieving the event log from the file store; and
generating a new hash value for the retrieved event log.

7. The method as claimed in claim 6 further comprising:
retrieving the hash value for the event log from the distributed blockchain;
comparing the new hash value with the hash value retrieved from the distributed blockchain; and
when the new hash value matches the hash value retrieved from the distributed blockchain, verifying that the event log is unaltered.

8. A system, comprising:
an event log generator configured to generate an event log comprising events which occurred during operation of the computer;
a hash generator configured to generate a hash value for the event log;
a blockchain manager module configured to add details of the event log and a hash value as a transaction to a distributed blockchain; and
a file store configured to store the event log.

9. The system as claimed in claim 8, wherein the event log is a log file.

10. The system as claimed in claim 8, wherein the details of the event log include a path of the event log and a name of the event log.

11. The system as claimed in claim 8, wherein the details of the event log comprise a timestamp indicating a time the event log was generated.

12. The system as claimed in claim 8, wherein the blockchain manager module is further configured to maintain a copy of the distributed blockchain including the transaction.

13. The system as claimed in claim 8, further comprising:
an event log verifier configured to:
retrieve an event log from the file store; and
generate a new hash value for the retrieved event log.

14. The system as claimed in claim 13, further comprising:
retrieve the hash value for the event log from the distributed blockchain;
compare the new hash value with the hash value retrieved from the distributed blockchain; and
when the new hash value matches the hash value retrieved from the distributed blockchain, verifying that the event log is unaltered.

15. A non-transitory computer-readable storage medium having computer-readable program code that when executed by a processor is configured to perform:
receiving an event log comprising events which occurred during operation of the computer;
generating a hash value for the event log;
adding details of the event log and the hash value as a transaction to a distributed blockchain; and
storing the event log in a file store.

16. The non-transitory computer-readable storage medium as claimed in claim 15, wherein the event log is a log file.

17. The non-transitory computer-readable storage medium as claimed in claim 15, wherein the details of the event log comprise a path of the event log and a name of the event log.

18. The non-transitory computer-readable storage medium as claimed in claim 15, wherein the details of the event log comprise a timestamp indicating a time the event log was generated.

19. The non-transitory computer-readable storage medium as claimed in claim 15, wherein the computer-readable program code, when executed by the processor, is further configured to perform adding the transaction to a copy of the distributed blockchain maintained by the computer.

20. The non-transitory computer-readable storage medium as claimed in claim 15, wherein the computer-readable program code, when executed by the processor, is further configured to perform one or more of:
retrieving the event log from the file store;
generating a new hash value for the retrieved event log;
retrieving the hash value for the event log from the distributed blockchain;
comparing the new hash value with the hash value retrieved from the distributed blockchain; and
when the new hash value matches the hash value retrieved from the distributed blockchain, verifying that the event log is unaltered.
